(19) United States
(12) Patent Application Publication
(10) Pub. No.: US 2016/0027280 A1
(43) Pub. Date: Jan. 28, 2016

(54) BODY WORN MONITORING SYSTEM WITH EVENT TRIGGERED ALERTS

(71) Applicants: Fahria Rabbi Khan, Fremont, CA (US); Ellen Ann O'Malley, Los Gatos, CA (US)

(72) Inventors: Fahria Rabbi Khan, Fremont, CA (US); Ellen Ann O'Malley, Los Gatos, CA (US)

(21) Appl. No.: 14/807,611

(22) Filed: Jul. 23, 2015

Related U.S. Application Data
(60) Provisional application No. 62/027,925, filed on Jul. 23, 2014.

(51) Int. Cl. G08B 21/04

(52) U.S. Cl. CPC G08B 21/0469

(57) ABSTRACT

A body worn system for monitoring a user's environment and providing event triggered alerts provides third parties with recorded audio and/or video of the user's environment prior to the triggering event. A continuously on recording module records audio and/or video of the user's environment and demarcates the data with a pre-set time buffer. In response to the triggering event, the demarcated data is provided to third parties for playback of the user's environment prior to the triggering event to provide context to the triggering event.

### CROSS-REFERENCE TO RELATED APPLICATIONS

This application claims benefit under 35 U.S.C. § 119(e) of U.S. Provisional Application having Ser. No. 62/027925 filed Jul. 23, 2014, which is hereby incorporated by reference herein in its entirety.

### BACKGROUND

The embodiments herein relate generally to systems providing event triggered alerts.

Current safety monitoring systems are passive and/or only provide an alert and recording of the triggering environment after the fact. There is very little information provided to aid those analyzing a scene for the impetus of the triggering event.

### SUMMARY

A body worn monitoring system for providing contextual audio and/or video data of a user's environment comprises a continuously on audio and/or video input device. A continuously on recording module may be coupled to the continuously on audio and/or video input device. A first general computing device may be coupled to the continuously on recording module. The first general computing device may: demarcate audio and/or video data provided by the continuously on recording module with a pre-set time buffer, detect a triggering event in the user's environment, and in response to the detected triggering event, transmit the demarcated audio and/or video data with the pre-set time buffer, the transmitted demarcated audio and/or video data providing to a third party a recording of the user's environment at a pre-determined time prior to the triggering event.

A computer program product for monitoring and providing contextual audio and/or video data of a user's environment, the computer program product comprising a non-transitory computer readable storage medium having computer readable program code embodied therewith, the computer readable program code being configured to: continuously record audio and/or video data of a first user's environment; demarcate the recorded audio and/or video data with a pre-set time buffer; analyze the recorded audio and/or video data with a pre-set time buffer for a triggering event; detect the triggering event in the analyzed recorded audio and/or video data with a pre-set time buffer; and in response to the detected triggering event, transmit the demarcated audio and/or video data with the pre-set time buffer to a third party, the transmitted demarcated audio and/or video data providing to the third party playing a recording of the user's environment at a pre-determined time prior to the triggering event.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a computer system/server according to an embodiment of the subject technology.

FIG. 2 is a block diagram of a network according to an embodiment of the subject technology.

FIG. 3 is a block diagram of a body worn monitoring system according to an embodiment of the subject technology.

FIG. 4 is a flowchart of a method for providing an alert to third parties by a body worn monitoring system according to an embodiment of the subject technology.

### DETAILED DESCRIPTION OF CERTAIN EMBODIMENTS

In general, embodiments of the disclosed invention provide a body worn system that provides alerts to third parties based on a triggered event. Some embodiments may be particularly useful for public safety personnel. The system may automatically transmit audio and/or video data to third parties so that the context of a triggered event may be witnessed. In an exemplary embodiment, always-on recording may be used so that the user's surrounding environment is recorded and when a triggering event is detected, the system demarcates within its recording files a previous section of recording for playback. The length of the previous section of recording may be pre-set dependent on the expected use of the system. The section of recording prior to the trigger event may be transmitted to a second user in response to the trigger event so the second user can see the context of the situation that led to the trigger event and may respond or come to the aid of the first user accordingly. For example, in one exemplary application, a police officer may be split up from a partner. The system may record his/her environment and once a triggering event (for example a gun is drawn or a gunshot is detected), the events leading up to the triggering event may be transmitted to the police officer's partner or dispatch so the scene can be evaluated for the reasons why the gun was drawn and/or to confirm whether live gunfire was actually detected. Thus a second police officer and/or additional backup has a better understanding of the situation being engaged. As will be appreciated, some aspects of the subject technology may be in the form of a computer program product processed by a general computing device. Details of the process(es) and the device(s) performing the process(es) are described more fully herein.

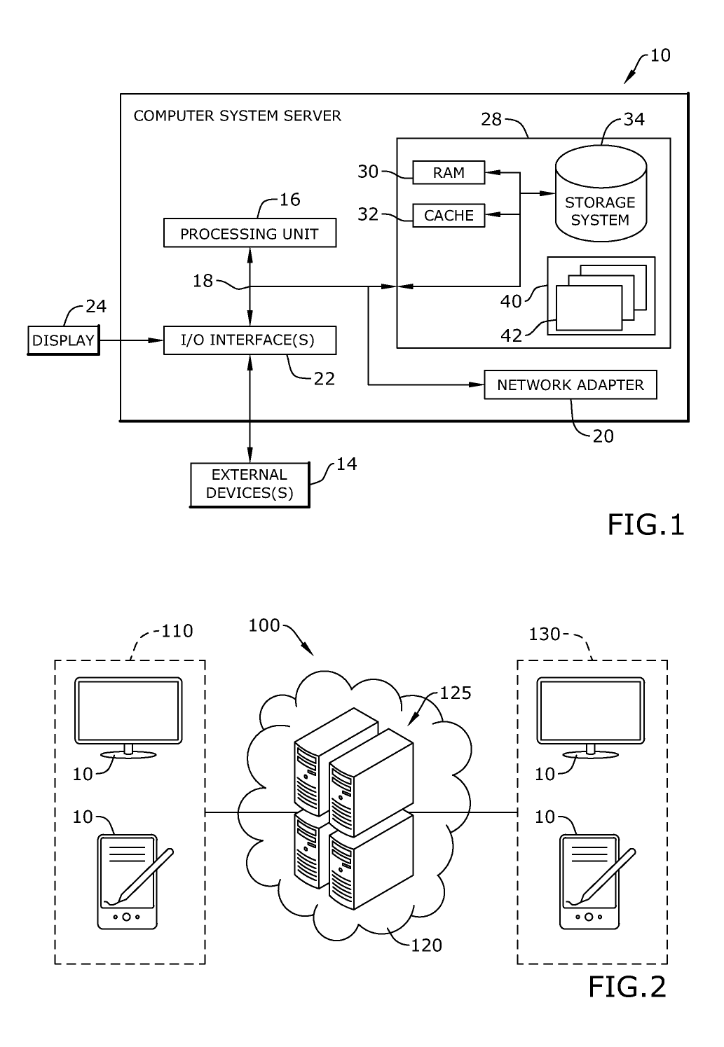

Referring now to FIG. 1, a schematic of an example of a computer system/server 10 is shown. The computer system/server 10 is shown in the form of a general-purpose computing device. The components of the computer system/server 10 may include, but are not limited to, one or more processors or processing units 16, a system memory 28, and a bus 18 that couples various system components including the system memory 28 to the processor 16.

The computer system/server 10 may perform functions as different machine types depending on the role in the system the function is related to. For example, depending on the function being implemented at any given time when interfacing with the system, the computer system/server 10 may be for example, personal computer systems, tablet devices, mobile telephone devices, server computer systems, handheld or laptop devices, multiprocessor systems, microprocessor-based systems, set top boxes, programmable consumer electronics, network PCs, and distributed cloud computing environments that include any of the above systems or devices, and the like. In some embodiments, the computer system/server 10 is a device worn by one or more users in the system (for example, a mobile telephone, tablet, wearable computing device, etc.). In some embodiments, the computer system/server 10 is an intermediary processing device receiving, analyzing, and transmitting data between users (for example, a personal computing device, hub server, etc.).

The computer system/server 10 may be described in the general context of computer system executable instructions, such as program modules, being executed by a computer system (described for example, below). In some embodiments, the computer system/server 10 may be a cloud computing node connected to a cloud computing network (not shown). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Referring now to FIG. 2, a block diagram of a system 100 for communicating triggered event alerts is shown. The system 100 may connect a user 110 to a third party 130 through a network 120. In some embodiments, the third party 130 may be a second user such as a police officer's partner. In some embodiments, the third party 130 may be an intermediary between the first user and the second user (for example, a dispatch office communicating with multiple officers). The network 120 may include a server 125 storing a software embodiment of the disclosed invention. The user 110 and third party 130 may interact with the system 100 with an electronic device (for example, a PC or mobile device). It will be understood that the electronic device used by the user 110 and the third party 130 and the server 125 may function for example, under the description the computer system/server 10 of FIG. 1. In some embodiments, the network 120 may be a cloud based environment. Computer program product embodiments of the subject technology may be processed one the device of the user 110, server 125, and third party 130 as described herein. In the description that follows, the computer system/server 10 may be referred to in general as the “device 10” which is worn by end users 110 and 130.

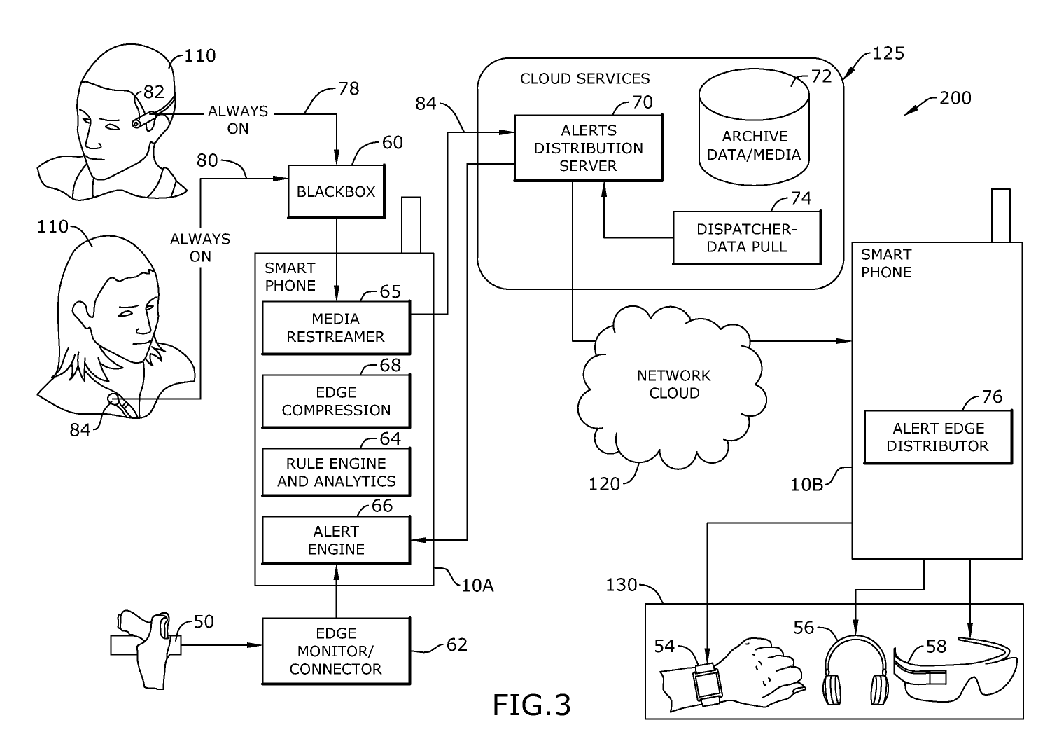

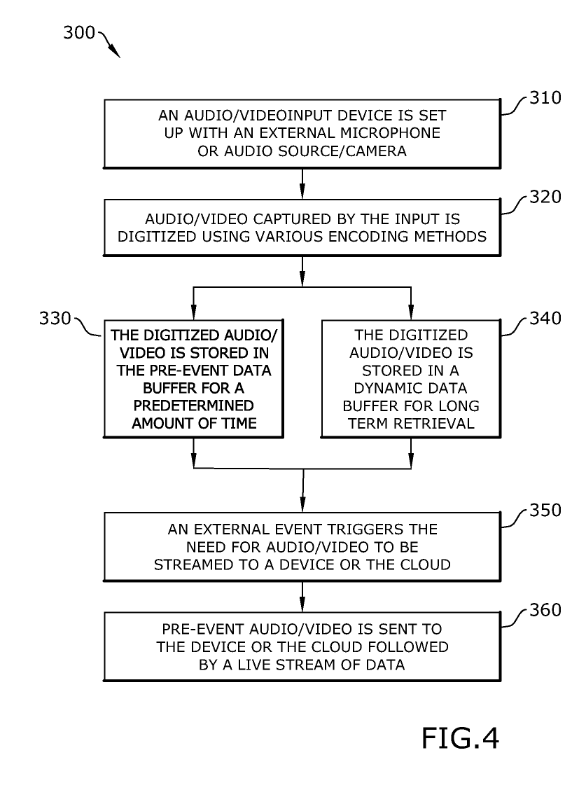

Referring now to FIG. 3, a system 200 for monitoring triggering events and issuing an alert is shown according to an exemplary embodiment of the subject technology. In an exemplary embodiment, the system 200 may be used by public safety personnel such as police officers or fire fighters. For sake of illustration, the context of the system 200 will be described as used by police officers in the field. The system 200 may continuously monitor a police officer's (first user's) environment for a triggering event. A triggering event may be based on an action associated with a device 50 worn by the user 110 or environmentally detected phenomenon. For example, the release or use of a firearm 50 from its holster or the firing of another weapon may be detected and trigger aspects of the system 200. For sake of clarity, device 10 of the user 110 will be referred to as device 10A and the device 10 of the third party user 130 will be referred to as device 10B. Use of the term “edge” refers to a device on the edge of a network. The system 200 also includes a video input 78 provided by a camera 82 worn on the user and an audio input 80 provided by a microphone 84 worn by the user 110. In an exemplary embodiment, the video input 78 and/or the audio input 80 is always-on recording the surrounding environment. While the following is described in the context of both audio and video data being provided, some embodiments may use audio or video exclusively. A recording module 60 may be connected to the video input 78 and/or the audio input 80. The recording module 60 may be always-on and also worn by the user 110. The recording module 60 may be wirelessly connected to the video input 78, the audio input 80, and/or the device 10A. The device 10a may include computer program products that include for example, a media re-streamer module 65 (for displaying audio/video data acquired by the video input 78 and the audio input 80), an edge compression module 68 that compresses audio/video data for re-transmission, a rule engine and analytics module 64 for processing audio/video data and sensor feedback, an alert engine 66 that issues an alert signal in response to the rule engine and analytics module 64 detecting a triggering event. Once a triggering action is detected by an edge monitor/connector module 62, the alert engine 66 provides a signal to the rule engine and analytics module 64 which forwards the signal to the media re-streamer 65 for distribution to third parties.

In an exemplary embodiment, the output from the recording module 60 may be processed (for example by a processing unit 16 as shown in FIG. 1) so that the audio/video data is continuously demarcated back in time by a pre-set time frame (for example 30 seconds) for every recorded frame. In response to a detected triggering event, a portion of the recorded audio/video data, starting at the demarcated point ahead of the triggering event may be transmitted to the server 125. In an exemplary embodiment, the server 125 may include an alerts distribution server 70. Data related to triggered events may be stored in a database 72. A dispatcher data pull module 74 may provide access to for example a dispatcher service that may evaluate the trigger alert and forwarded audio/video data. The dispatcher data pull module 74 may forward confirmed triggered events through the alerts distribution 70 to the third party user 130. In another example of use, an Incident Response Coordinator, such as, a Public Safety Dispatcher may be monitoring the activities of Policemen who are in the middle of an assignment, and realize that someone may be in danger. In that scenario, the Dispatcher can initiate a request to the system 200 to retrieve audio/video data from that Policeman's local recordings on their recording module 60. These recordings would be tagged with each alert triggered and will include the pre-audio/video segment associated with each alert, thereby allowing quick access to relevant portions of the audio/video for better decision-making by the Public Safety Dispatchers. The third party user 130 may receive the forwarded audio/video data via an alert distributor module 76 in the user's 130 device 10B. The received audio/video data may display the user's 110 environment prior to the triggering event on the device 10B. The device 10b may be connected to peripheral devices 54 (a smart watch) 56 (headphones), and/or 58 (smart glasses/heads-up display gear) for perceiving the displayed/broadcast transmission.

Referring now to FIGS. 2 and 3 concurrently, an exemplary use of the system 200 is described in the context of a method 300 for providing an alert to third parties according to exemplary embodiments of the subject technology. The blocks below describe actions which may be performed by a processing unit (for example processing unit 16 of FIG. 1) unless noted otherwise. In block 310, an audio/video input device may be set up by a first user with an external microphone or audio source/camera. In block 320, recorded data captured by the audio/video input is digitized an encoded for transmission. In block 330, the digitized audio/video data is stored in the pre-triggering event data buffer for a predetermined amount of time (for example, a 30 second buffer). In block 340, the digitized audio/video data is stored in a dynamic data buffer storage for long term storage and retrieval. In block 350, an external event triggers the need for the recorded audio/video including the pre-triggering event data and the dynamic data to be streamed to a third party device. In block 360, the audio/video data of the user's environment including the pre-triggering event data is sent to a third party user. The pre-triggering event data may be followed by live streaming audio/video data of the first user's environment.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A body worn monitoring system for providing contextual audio and/or video data of a user's environment, comprising:
a continuously on audio and/or video input device;
a continuously on recording module coupled to the continuously on audio and/or video input device; and
a first general computing device coupled to the continuously on recording module, the first general computing device configured to:
demarcate audio and/or video data provided by the continuously on recording module with a pre-set time buffer,
detect a triggering event in the user's environment, and
in response to the detected triggering event, transmit the demarcated audio and/or video data with the pre-set time buffer, the transmitted demarcated audio and/or video data providing to a third party a recording of the user's environment at a pre-determined time prior to the triggering event.

2. The body worn system of claim 1, further comprising a second general computing device configured to receive the transmitted demarcated audio and/or video data with the pre-set time buffer and play the recording of the user's environment at the pre-determined time prior to the triggering event to provide context of the triggering event.

3. The body worn system of claim 1, wherein the first general computing device is further configured to provide a live audio and/or video stream of the first user's environment following the recording of the user's environment at the pre-determined time prior to the triggering event.

4. The body worn system of claim 1, wherein the triggering event is based on a detected use of a firearm.

5. The body worn system of claim 1, further comprising a dispatcher data pull module connected via a network to the first general computing device, the dispatcher data pull module providing access to the transmitted demarcated audio and/or video data with the pre-set time buffer to a dispatcher service.

6. A computer program product for monitoring and providing contextual audio and/or video data of a user's environment, the computer program product comprising a non-transitory computer readable storage medium having computer readable program code embodied therewith, the computer readable program code being configured to:
continuously record audio and/or video data of a first user's environment;
demarcate the recorded audio and/or video data with a pre-set time buffer;
analyze the recorded audio and/or video data with a pre-set time buffer for a triggering event;
detect the triggering event in the analyzed recorded audio and/or video data with a pre-set time buffer; and
in response to the detected triggering event, transmit the demarcated audio and/or video data with the pre-set time buffer to a third party, the transmitted demarcated audio and/or video data providing to the third party playing a recording of the user's environment at a pre-determined time prior to the triggering event.

7. The computer program product of claim 6, further comprising computer readable program code being configured to transmit the transmitted demarcated audio and/or video data to a second general computing device for playback of the recording.

8. The computer program product of claim 6, further comprising computer readable program code being configured to provide a live audio and/or video stream of the first user's environment following the recording of the user's environment at the pre-determined time prior to the triggering event.
